(19) United States
(12) Patent Application Publication
(10) Pub. No.: US 2024/0269850 A1
(43) Pub. Date: Aug. 15, 2024

(54) PREDEFINING A PERMISSIBLE MAXIMUM SPEED OF A ROBOTIC DEVICE

(71) Applicant: Fraunhofer-Gesellschaft zur Förderung der Angewandten Forschung E.V., München (DE)

(72) Inventors: Roland BEHRENS, Magdeburg (DE); Sebastian HERBSTER, Magdeburg (DE)

(21) Appl. No.: 18/681,107

(22) PCT Filed: Aug. 3, 2022
(86) PCT No.: PCT/EP2022/071805

§ 371 Date: Feb. 5, 2024

(30) Foreign Application Priority Data
Aug. 6, 2021 (DE) 10 2021 208 576.8

(51) Int. Cl. B25J 9/16

(52) U.S. Cl. CPC B25J 9/1676; B25J 9/163; B25J 9/1651; B25J 9/1653

(57) ABSTRACT

Predefining a permissible maximum speed for a robotic device may include predefining a contact point between a human operator and the robotic device for a collision between the human operator and the robotic device, a geometry of the robotic device at the contact point, and a spatial boundary condition of the collision. The method may also include determining whether the collision is a clamp-free collision or a clamped collision using a computing unit. The method may also include calculating, by the computing unit, the permissible maximum speed of the robotic device at the contact point with a free-impact model, and with a clamping-impact model or with a quasi-static-clamping model. The method may also include using the computing unit to output a signal dependent on the calculated permissible maximum speed for the robotic device to predefine the permissible maximum speed of the robotic device.

The invention relates to a computer-implemented method for predefining a permissible maximum speed of a robotic device, as well as a corresponding control unit.

To prevent or reduce accidents and injuries with robotic devices, it is necessary to safeguard mechanical human-machine interfaces which have moving parts. Such human-machine interfaces are present, for example, in a collaborative robotic device/robot, a so-called cobot. In principle, there is a risk of injury here due to a collision between the respective moving parts of the robotic device, the machine, and body parts of a human operator, a user. The risk of injury or accident may be reduced by limiting the performance of the robotic device to such an extent that the device poses no risk of injury or only a reduced risk of injury.

In general, a limitation of performance may be achieved by limiting the force and/or power of the robotic device. Known biomechanical limit values, quantified for example in relevant standards, indirectly specify correspondingly for safe operating modes of robotic devices how much the power of a robotic device, for example the speed of moving parts of the robotic device, should be limited so that a collision with a human does not result in impermissible overstressing of human tissue and consequently pain or even injury.

Validation of the limit values, i.e., compliance with them, at the robotic device by means of physical measurements is nowadays established. The disadvantage of this is that the corresponding measurements are only possible after the robotic device has been put into operation and therefore the maximum achievable speed or performance limits may only be determined retrospectively. As a result, corresponding permissible control signals may also only be generated retrospectively, which leads to long iteration loops and a high degree of planning uncertainty.

The theoretical understanding of the abstract assessment of a collision between a human and an elastic robotic device was significantly influenced by the article “Fast and “Soft Arm” Tactics” by Bicchi, A. et. al, published in IEEE Robot. Automat. Mag. 11(2), pages 22-33, from 2004. There, a head injury risk is proposed using a three-mass oscillator model. However, this model is only suitable for hard body parts such as the head.

A three-mass oscillator model is likewise used in the article “On Impact the Decoupling Properties of Elastic Robots and Time Optimal Velocity Maximization on Joint Level” by Haddadin S. et al., published in Proceedings of 2012 IEEE/RSJ—International Conference on Intelligent Robots and Systems, pp. 5089 to 5096. In order to depict a worst-case scenario, the drive inertia is assumed to be an infinite mass, which, however, leads to significantly excessive collision forces and thus to unnecessarily reduced permissible maximum speeds in a realistic scenario.

The article “A New Approach to Estimate the Apparent Mass of Collaborative Robot Manipulators” by Herbster S. et al. in “Experimental Robotics”, Cham: Springer International Publishing, pp. 211-221, from 2021 also uses a three-mass oscillator model. Assuming linear characteristic curves, an analytical solution for a safe speed, i.e., a permissible maximum speed, is described there.

The object is therefore to specify a permissible maximum speed of a robotic device, at which the biomechanical limit values for avoiding injuries are reliably complied with, in the most efficient way possible in order to be able to determine the highest possible permissible maximum speed, particularly in real-time applications.

This object is achieved by the subject matter of the independent claims. Advantageous embodiments may be found in the dependent claims, the description and the figures.

One aspect relates to a computer-implemented method for predefining a permissible maximum speed of a robotic device/for a robotic device. The maximum speed relates here in particular to one or more points moving at the highest speed of all points on the surface of the robotic device at respective points in time with a predefined machine path or trajectory of the robotic device. In particular, the robotic device may be a collaborative robotic device, a so-called cobot. In general, however, the method described may be applied to any machine with physical interfaces to humans.

One method step here is predefining at least one contact point between a human operator and the robotic device for a collision between the human operator and the robotic device, a geometry of the robotic device at the contact point, and a spatial boundary condition of the collision. In particular, the geometry of the robotic device may include tool and/or workpiece data. A tool used by the robotic device or a workpiece processed by it may thus be considered and taken into account as part of the robotic device. The selection of the contact point between the human and the machine, i.e., the operator and the robotic device, as well as the spatial boundary condition, for example whether a human body part belonging to the contact point is trapped or free, may be carried out manually by a user or also (partially) automatically. The user or the (partially) automated input may specify one or more contact points for a collision or several contact scenarios, each with associated collisions between the operator and the robotic device. The geometry of the robotic device associated with a collision may, for example, be selected manually by the user using a list or automatically, for example based on a 3D model of the robotic device, possibly including the tool and workpiece.

In a further method step, under consideration of the predefined spatial boundary condition, it is determined whether the collision is a clamp-free collision or a clamped collision using a computing unit. In the case of a collision with several contact points, a collision may also occur that is both clamp-free and clamping. In this case, the collision may, for example, be divided into two separate sub-collisions for the present method, for each of which the method described is then carried out individually. At the end of the respective individual methods, as with the predefining of a permissible maximum speed for the robotic device for a plurality of collisions or a plurality of contact points, as explained further below, the different results for the permissible maximum speed may then be compared with each other and a suitable, for example the lowest maximum speed may be predefined as the permissible maximum speed, i.e., calculated and provided for the output described below.

The calculation of the permissible maximum speed of the robotic device at the contact point is therefore a further method step. This is done using a free-impact model if the collision is a clamp-free collision, and with a clamping-impact model and/or with a quasi-static-clamping model if the collision is a clamped collision. The models are different models in each case. The free-impact model is used here for a “free impact”, i.e., a comparatively fast collision in which the contact point on the human body part or the human body part belonging to the contact point is not opposed by any external resistance in a collision direction, a direction of movement of the contact point on the robotic device during the collision, i.e., the human body part is able to evade. The clamping-impact model likewise relates to a comparatively fast collision, in which the human body part assigned to the contact point is unable to evade, i.e., encounters external resistance and is therefore trapped. The quasi-static-clamping model is now used for slow collisions compared to the aforementioned fast collisions, in which slow collisions the contact point on the human body part or the human body part associated with the contact point is also subjected to external resistance in the direction of collision, i.e., the body part is unable to evade the clamping impact.

The different models are stored here in the computing unit that calculates the permissible maximum speed and, as described further below, may determine respective maximum speeds on a model-specific basis based on partly identical and partly different input variables. Whether the collision is comparatively fast or comparatively slow, i.e., whether the clamping-impact model or the quasi-static-clamping model is to be used, may be predefined here, for example, by setting corresponding speed limit values, alternatively or additionally by applying both models, i.e., by simulating the collision separately using two different simulations and then comparing the results, in each case resulting in permissible maximum speeds. Of these, for example, the lower one may be selected for the further part of the method.

Lastly, the computing unit outputs a control signal that is dependent on the calculated permissible maximum speed for the robotic device, which may also be selected from several calculated maximum speeds, and in particular represents the calculated permissible maximum speed. The control signal may be a control signal that may be read directly here by the robotic device, or alternatively a control signal that indicates correspondingly to a human user of the method the maximum speed at which the robotic device is to be controlled, for example via a display unit. Accordingly, the computer-implemented method may be implemented as a program sequence in a virtual planning tool, for example with virtual robotic devices that are virtually controlled by the control signal, or directly in a control unit of a robotic device. The required data regarding the tool, safety configuration, description of kinematics, mass, inertia, center of gravity, joints and corresponding motors as well as torques of the robotic device on the one hand, as well as limit values, stiffness characteristic curves and masses of the body site affected by the collision are stored in corresponding databases and provided to the method. The data used will be discussed in greater detail below. The signal may also be a warning signal which, for example in a real-time application, indicates that the actual speed of the robotic device is higher than the permissible maximum speed.

To calculate the permissible maximum speed, the method accesses parameters that are stored in databases or models. Once the calculation has been completed, the method, and therefore the algorithm, outputs a safe speed, i.e., a permissible maximum speed for the robotic device, at which the considered machine part involved in the collision no longer exceeds the stored biomechanical limit values that are permissible according to a standard valid in July 2021, such as ISO/TS 15066, in the event of the collision under consideration. In the case of several pairings of contact points and contact geometries in one or more collisions, the lowest of the calculated safe speeds may be selected for output.

Compared to the previous approaches, the advantage here is, initially, that the clamping impact and the quasi-static clamping are combined in a uniform approach, but are still taken into account individually. This makes it possible to calculate exactly which speed is still a safe speed with a low risk of injury for both relatively slow and relatively fast collisions.

This is based on the knowledge that the system behavior is highly non-linear, i.e., the restriction to a uniform model for all clamping, fast and slow clamping, clamping impact and quasi-static clamping, results in permissible maximum speeds that deviate greatly from the real limit values for the other case and is therefore highly inaccurate. In addition, the method described is suitable both for so-called offline (planning) calculation and for real-time calculation of the respective permissible maximum speeds of machines, in particular robotic devices with physical interfaces to humans. A particular example here is constituted by collaborative robotic devices that interact with humans and operate in the power and force limitation mode in accordance with ISO/TS 15066. The method described may be used to ensure compliance with the predefined limit values, such as the known biomechanical limit values, and thus minimize the risk of collisions causing impermissible stresses, i.e., pain and/or injury, to the operator.

The above-mentioned method may be used to optimize and validate predefined trajectories, or more precisely: the permissible speeds of moving machine parts along a machine path traversed by the robotic device—the trajectory. Different spatial conditions and temporal conditions of the collision may be specifically addressed, which results in the particular accuracy of the method.

A further insight underlying the invention is therefore that the use of different models is more favorable in terms of overall efficiency than the use of a single model, although the initial configuration required is more complex. The method may also take into account different surface shapes at the contact point of the colliding machine part, including tool and workpiece, as well as the non-linear stiffness characteristic curves at the contact point both for loaded soft tissue of the operator and for the surface of the machine at the contact point, which may also deform in the event of a collision. The method may also be applied to different points along the machine surface, including the tool and workpiece, so that a particularly comprehensive assessment of injury risks and thus a particularly reliable determination of the permissible maximum speed is achieved.

In an advantageous embodiment, it is provided that the output control signal represents a location-dependent speed specification along a machine path predefined for the robotic device, a trajectory of the robotic device or one or more parts of the robotic device. The speed specification is location-dependent here in that it is predefined along the machine path and thus at different locations for the respective machine parts of the robotic device. In particular, the location-dependent speed specification may be generated by scaling a speed specification originally predefined for the predefined machine path, preferably likewise location-dependent, in dependence on the calculated maximum speed. An original location-dependent speed specification along a machine path, which may be unsafe, may therefore be replaced by an equivalent location-dependent speed specification, which ensures that a safe permissible maximum speed is predefined along the predefined machine path.

The scaling here may comprise or be a uniform, i.e., location-independent scaling of the predefined maximum speed or a scaling adapted locally to the predefined machine path. With uniform scaling, the predefined permissible maximum speed is therefore multiplied by a fixed factor as a function of the location along the machine path so that a safe speed, at which injuries may be ruled out as described above, is not exceeded at one or more speed extremes of the original speed specification. In the case of scaling adapted locally to the predefined machine path, the speed may be reduced accordingly for sub-sections of the machine path in which the original speed specification is above a safe speed, and the speed may be increased in sub-sections of the machine path in which the originally predefined speed specification is below a determined safe maximum speed. A predefined process speed for the robotic device may be taken into account on one or more sub-sections of the machine path, in particular in such a way that the originally predefined maximum speed specification is not adjusted there, for example. This is advantageous, for example, if, at such a sub-section for the technical process carried out by the robotic device, a speed is required that may be increased for safety reasons but, for the process itself, is low in relation to the calculated permissible maximum speed. This has the advantage that the overall process of the robotic device may be safely optimized, i.e., its speed may be increased.

In an alternative embodiment, it is provided that the permissible maximum speed is calculated in real time and the control signal output represents an instantaneous permissible maximum speed for the robotic device, so that an instantaneous actual speed of the robotic device at the predefined contact point may be adapted to the instantaneous permissible maximum speed. This is advantageous, for example, in the case of manually or semi-automatically controlled devices in which the instantaneous speed of the robotic device is controlled or influenced by an operator.

In a further advantageous embodiment, it is provided that, if the collision is a clamped collision, the permissible maximum speed is calculated with the clamping-impact model and with the quasistatic-clamping model, and a lower one of the calculated maximum speeds is selected as the permissible maximum speed on which the output signal is dependent. This has the advantage that an implicit distinction is made between faster and slower collisions, i.e., a rigid and possibly incorrect limit value does not have to be set from the outset, but preference is given to the safer maximum speed.

In a further advantageous embodiment, the permissible maximum speed is calculated in the quasi-static-clamping model in dependence on:
a) a predefined kinematic structure of the robotic device,
b) a joint configuration at the time of the collision, in particular with a position of one or more axes of the robotic device and speeds assigned to the respective axes,
c) a stiffness characteristic curve of a human body site at the contact point of the collision,
d) a stiffness characteristic curve of a machine point at the contact point of the collision,
e) a resultant stiffness characteristic curve calculated with the stiffness characteristic curve of the human body site and the stiffness characteristic curve of the machine point,
f) a predefined added maximum deformation, in particular with or from a biomechanical force threshold value and/or an energy threshold value and/or a deformation threshold value,
g) a permissible penetration depth calculated with the stiffness characteristic curve of the machine point and the resulting stiffness curve,
h) a reaction force of the robotic device,
i) a reaction distance of the robotic device calculated using the stiffness characteristic curve of the machine point and the permissible penetration depth,
j) a permissible braking distance of the robotic device calculated using the predefined permissible maximum deformation and the reaction force, and
k) an actual braking distance of the robotic device.

The predefined kinematic structure of the robotic device according to a) describes here the general arrangement of the joints, for example as a Denavit-Hartenberg parameter. The joint configuration at the time of the collision according to b) transfers, in particular, axis positions and axis speeds of the robotic device to the method or the algorithm by a corresponding control unit of the robotic device or a virtual (offline) planning tool, for example triggered by a human input. If a trajectory of the robotic device is transferred, the joint configurations are calculated and transferred accordingly for each individual time step. Accordingly, the method may then be used to calculate a safe speed for each time step along the trajectory.

The stiffness characteristic curve of the human body site according to c) depends on the affected body part and the geometry of the machine at the contact point. It quantifies the dependency of a force acting on the body part during the collision in relation to the deformation of the body part in question and is generally distinguished by a non-linear behavior. The stiffness characteristic curve of the human body part affected by the collision and the associated limit values may be taken here from a tabular list, in particular as per ISO/TS 15066, determined on the basis of a contact model, a simulation, or determined experimentally. Known tabular listings include, for example, the affected body part and the shape of the geometry of the robotic device at the contact point. Contact models, on the other hand, may calculate a contact geometry-dependent stiffness characteristic curve and associated force or energy limit values on the basis of specific material parameters for each body part or contact point on the body part and biomechanical limit values.

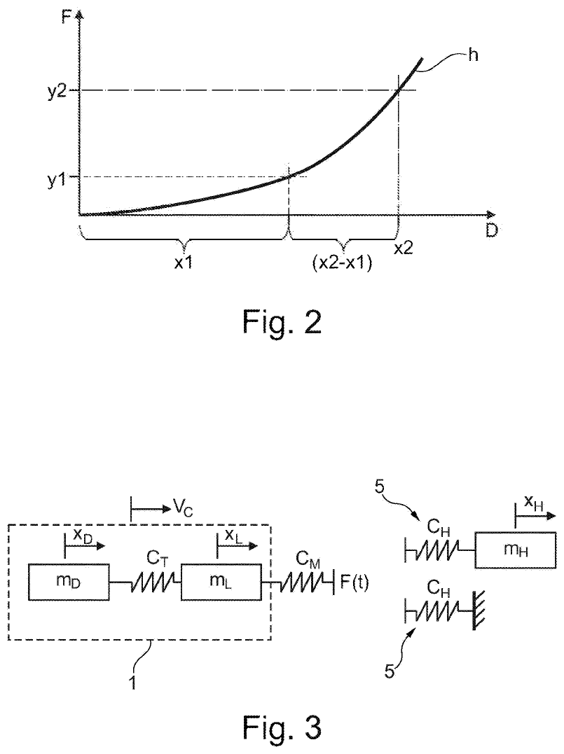

The machine point at the contact point according to d) may also have an equivalent to the stiffness of the human body site. Similarly to the stiffness characteristic curve of the human body site, the corresponding stiffness characteristic curve may be given by an entry in a database, a simulation or experimental data. It may also represent a non-linear behavior. An effective stiffness characteristic curve according to e) results from the stiffness characteristic curve of the human body site according to c) and the stiffness characteristic curve of a machine point at the contact point according to d). Such a resulting stiffness characteristic curve is shown in FIG. 2, for example, and generally establishes a relationship between a force acting on the human body site at the contact point in the event of a collision with the machine point and a deformation of the human body site at the contact point resulting from this force. If the acting force exceeds a permissible biomechanical contact force here, the permissible penetration depth is also exceeded, which results in damage, i.e. injury to the human body site.

The predefined permissible maximum deformation according to f) as a biomechanical limit value is a limit value dependent on the body part and contact geometry. Accordingly, it may be present with or as a force threshold value/limit value and/or energy threshold value/limit value and/or deformation threshold value/limit value. A distinction may be made here between fast (transient) and slow (quasi-static) values for the respective limit values for impact and clamping loads. The quasi-static specifications or values are relevant for the quasi-static-clamping model, while the transient limit values are relevant for the free-impact model or clamping-impact model. The different force, energy or deformation limit values may be converted into each other using the given stiffness characteristic curve of the human body site. The biomechanical force limit value is required for this calculation, as explained, for example, in conjunction with FIG. 2.

The permissible penetration depth according to g) may be determined from the biomechanical force limit value and the resulting stiffness characteristic curve. In FIG. 2, it corresponds to the intersection of the permissible biomechanical contact force and the resulting stiffness characteristic curve. The reaction force of the robotic device according to h) is a force limit value that may be set at the robotic device, with the robotic device triggering a safety stop if the force limit value is exceeded. Such a safety stop usually involves asynchronous braking with maximum deceleration of all axes, wherein no path fidelity is given. An exemplary reaction force is also shown in FIG. 2. The settable force limit value may often be set for the operating point of the robotic device over specific axes. It may also be set as an axis-specific force or torque limit value, which is indicated specifically for the respective drives of the robotic device. The axis-specific force or torque limit values may be converted into a general force limit value using the axis position, the machine point at the contact point, i.e., the contact point on the machine surface, and the collision direction.

In principle, the force limit value may be defined for any machine point, i.e., for any contact point on the surface of the machine. A set force limit value at a machine point, e.g., an end effector of a robotic device, may generally be converted to a force limit value for any other machine point. In turn, axis-specific force or torque limit values do not have to be given for all axes. If the axis position is unfavorable, the robotic device may not detect the collision in such a case. This is the case if none of the monitored axis-specific forces or torques are addressed by the force input in the event of a collision. Frequently, both force limit values for the operating point and axis-specific force or torque limit values, both generally referred to as monitored limit values, are set, i.e., predefined and activated, at a robotic device. In such a case, the lower of the two resulting limit values must be taken into account as the reaction force at the robotic device for further considerations.

The calculated reaction distance of the robotic device according to i) may result from the set reaction force at the operating point of the machine and the resulting stiffness characteristic curve. The intersection of the limit value and the characteristic curve then corresponds to the length of the reaction distance, as also shown in FIG. 2. The permissible braking distance of the robotic device according to j) results from the permissible penetration depth minus the reaction distance of the machine. An exemplary permissible braking distance is also shown in FIG. 2. If the reaction force on the robotic device is greater than the permissible contact force at the respective body position, there is no safe speed. In this case, the robotic device must not move until the affected body part is outside the danger zone.

In the event of a safety stop, a robotic device usually performs asynchronous braking, in which case all axes are decelerated to the maximum and a loss of path accuracy is accepted. The axis position of the robotic device after such a braking process is calculated here from the speeds of the axes at the time of the collision, the axis positions from which the outreach may be determined, the additional load at the working point or tool and the braking angle traveled. The braking angle may either be taken from the manufacturer's specifications or calculated on the basis of the possible deceleration or determined experimentally. The deceleration in turn results from the forces or torques available in the axes and the dynamics of the robotic device considered as a machine system. With a known kinematic structure, the distance traveled in the collision direction may be calculated for any point on the machine, i.e., for each machine point as the contact point of the collision, taking into account the difference in distance of the collision point before and after the end of the braking process. This distance traveled then corresponds to the actual braking distance of the machine according to k).

In an advantageous embodiment, the permissible maximum speed may be determined iteratively based on the reaction force of the robotic device until the actual braking distance corresponds to the permissible braking distance. A bisection method is particularly suitable here. The permissible maximum speed may be calculated particularly quickly using the variables described above due to fewer iteration steps.

In another advantageous embodiment, if the collision involves contact points on different parts of the human body, the control signal output depends on the permissible maximum speed, which corresponds to the shortest actual braking distance in dependence on the predefined permissible maximum deformation and the resulting stiffness curve. This does not necessarily have to be the lowest permissible maximum speed at the various contact points. This has the advantage that injuries are avoided particularly effectively, as it is not the maximum speed itself that is considered, but the respective contact points of the collision(s) that are evaluated with regard to the required braking distance.

In a further advantageous embodiment it is provided that if the collision involves contact points at different machine points, the permissible maximum speed for all contact points is calculated and the output signal is dependent on the lowest permissible maximum speed. In contrast to what was described in the last paragraph, it has been found for different machine points that the maximum speed itself, and not the actual braking distance, is best suited for limiting the risk of injury.

In a further advantageous embodiment it is provided that in the case of the free-impact model and the clamping-impact model, the permissible maximum speed is calculated in each case in dependence on:
a) the predefined kinematic structure of the robotic device,
b) the joint configuration at the time of the collision, in particular with a position of one or more axes of the robotic device and speeds assigned to the respective axes,
c) the stiffness characteristic curve of the human body site at the contact point of the collision,
d) the stiffness characteristic curves of the machine point at the contact point of the collision,
e) the resultant stiffness curve calculated with the stiffness characteristic curve of the human body site and the stiffness curve of the machine point, and
f) the permissible maximum deformation predefined with a biomechanical force threshold value and/or a biomechanical energy threshold value.

The stated values correspond to the values already described above for the quasi-static-clamping model.

In addition, the additional maximum speed is calculated here in dependence on:
l) an effective mass of the machine point at the contact point of the collision, and
m) an effective stiffness of the robotic device.

Only with the free impact model is the maximum speed also calculated in dependence on:
n) an effective mass of the human body site at the contact point of the collision.

The effective mass of the machine point according to l) is calculated here according to Khatib O. and may be found correspondingly in the article “A Unified Approach for Motion and Force Control of Robotic Manipulators: The Operational Space Formulation”, published in 1987 in IEEE Journal of Robotics and Automation 3(1), pp. 43 to 53, and the 1995 article “Inertial Properties in Robotic Manipulation: An Object-Level Framework” in: The International Journal of Robotics Research 14(1), pp. 19-36, as follows: The arrangement of the machine parts at the time of collision (the axis position), the dynamic mass properties, the kinematic structure of the robotic device (the geometric arrangements of the axes, etc.), a collision direction and a collision point. The dynamic mass properties of the robotic device may also be calculated with or without the inertia of the drive. This results in either an effective mass of the robotic device without consideration of the drive inertia or an effective mass of the robotic device with consideration of the drive inertia, and the effective drive mass is calculated from the difference between the two effective masses. When calculating with consideration of the drive inertia, the transmission ratio of the individual drives of the robotic device must be taken into account. The Khatib method is particularly suitable for calculating a serial arrangement of machine parts that move in relation to each other, for example the different elements of a robotic chain in an articulated robot. However, the method may also be used for parallel kinematic chains and mixed forms.

The effective stiffness of the robotic device n) may be calculated according to J.-K. Salisbury, “Active stiffness control of a manipulator in cartesian coordinates”, published in the Proceedings of the Conference on Decision and Control including the Symposium on Adaptive Processes, pp. 95-100, 1980, and A. Albu-Schäffer, M. Fischer, G. Schreiber, F. Schoeppe, and G. Hirzinger, “Soft robotics: what cartesian stiffness can obtain with passively compliant, uncoupled joints?”, published in the Proceedings of the 2004 IEEE/RSJ International Conference on Intelligent Robots and Systems (IROS), pp. 3295-3301 vol. 4, Sendai, Japan, February 2004, depending on the arrangement of the machine parts at the time of collision, the stiffnesses of the individual drive trains, the kinematic structure of the robotic device, the collision direction and the collision point. There, the effective drive mass is coupled elastically with the effective mass of the axes according to an equivalent model, as shown correspondingly in FIG. 3, for example. The stiffness between these masses then results in the effective stiffness.

To determine the forces for the spatial condition of a free impact, a clamp-free collision, the effective mass of the human according to n) is required. The effective mass of the human is calculated here either using a dynamic mass model of the human or is taken from a tabular list, for example as per ISO/TS 15066. Dynamic mass models typically take into account the body posture (i.e. the position of the individual joints), dynamic mass properties such as those dependent on gender, height and weight, for example, the direction of collision and the point of collision. Tabular listings typically include the affected body segment and body posture. In the event of a clamping impact, the human body part, the human body site, is unable to avoid the force applied, i.e. it is unable to retreat. Accordingly, in an equivalent model, the human body site must be regarded as firmly trapped.

With the given variables as parameters, a simulation model for the free-impact model or the clamping-impact model may be constructed as shown in FIG. 3, for example. Accordingly, the free-impact model may comprise or be a three-mass oscillator model and/or the clamping-impact model may comprise or be a two-mass oscillator model. The models are suitable for drawing conclusions about a force curve at the contact point based on the collision speed. The transmitted energy and maximum force may be determined from the force curve and in turn may be used to draw conclusions about expected injuries via the resulting stiffness characteristic curve, and a safe speed may be predefined as the permissible maximum speed accordingly.

The calculation of the safe speed as the permissible maximum speed is possible here analytically if the resulting stiffness characteristic curve at the contact point is linear, and is only possible numerically if the resulting stiffness characteristic curve at the contact point is non-linear. It may also be possible here to linearize the resulting stiffness characteristic curve at the intersection of the characteristic curve and the biomechanical force limit value in order to speed up the method. In this case, for example, an initial estimate of the permissible maximum speed may be derived on the basis of the analytical solution, which may then be used as the initial value for a numerical solution.

It should be noted here that in the case of a transient, i.e., relatively fast collision, the drive controllers of the robotic device may be neglected, as the collision duration is usually too short for the controller to intervene. Accordingly, the monitored reaction force set at the machine generally has no influence on impacts. Biomechanical limit values that are smaller than the set monitored reaction force of the robotic device may usually be complied with in the event of impacts.

Another aspect also relates to a control unit for predefining a permissible maximum speed of a robotic device. Such a control unit is equipped with a detection unit for detecting a contact point between a human operator and the robotic device for a collision between the human operator and the robotic device, for detecting a geometry of the robotic device at the contact point, and for detecting a spatial boundary condition of the collision. Furthermore, the control unit has a computing unit for determining, under consideration of the physical boundary condition, whether the collision is a clamp-free collision or a clamped collision, and for calculating the permissible maximum speed of the robotic device at the contact point with a free-impact model if the collision is a clamp-free collision and with a clamping-impact model or with a quasistatic-clamping model if the collision is a clamped collision. The models are different models in each case. The computing unit is also configured to output a control signal dependent on the calculated permissible maximum speed for the robotic device. A further aspect relates to a robotic device comprising such a control unit.

Advantages and advantageous embodiments of the control unit and of a robotic device equipped with the control unit correspond here to advantages and advantageous embodiments of the described method.

The features and combinations of features mentioned above in the description, also in the introductory part, as well as the features and combinations of features mentioned below in the description of the figures and/or shown alone in the figures may be used not only in the combination indicated in each case, but also in other combinations, without departing from the scope of the invention. Thus, embodiments which are not explicitly shown and explained in the figures, but which emerge from the explained embodiments and may be produced by separate combinations of features, are also to be regarded as comprised and disclosed by the invention. Embodiments and combinations of features which thus do not have all the features of an originally formulated independent claim are also to be regarded as disclosed. Furthermore, embodiments and combinations of features are to be regarded as disclosed, in particular by the embodiments set out above, which go beyond or deviate from the combinations of features set out in the references of the claims.

The subject matter according to the invention will be explained in greater detail on the basis of the following figures and schematic drawings, without wishing to limit these to the specific embodiments shown here.

The figures show:

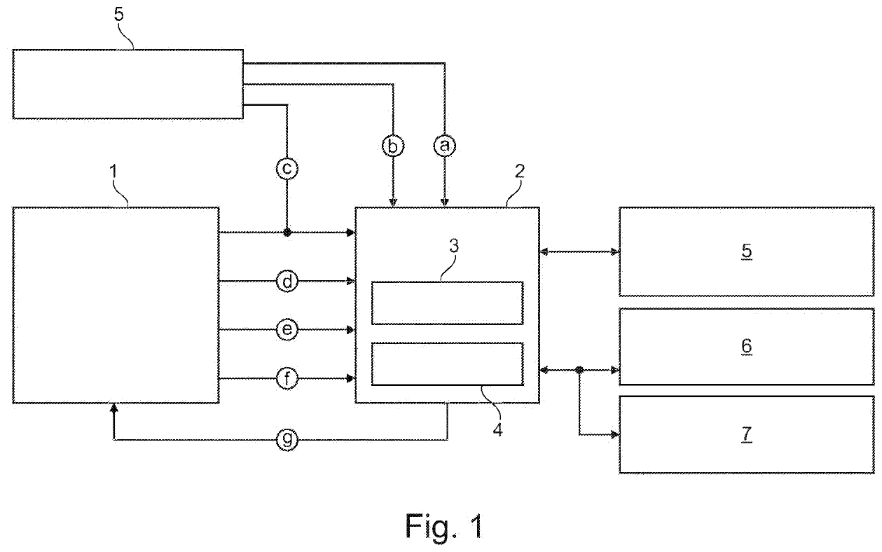

FIG. 1 an exemplary robotic device with an exemplary embodiment of a control unit for predefining a permissible maximum speed of the robotic device;

FIG. 2 an exemplary resulting stiffness characteristic curve at a contact point; and

FIG. 3 substitute models for an exemplary free-impact model and an exemplary clamping-impact model.

In the different figures, like or functionally like elements are provided with like reference signs.

FIG. 1 shows a robotic device 1 with a control unit 2 for predefining a permissible maximum speed of the robotic device (1). The control unit 2 in this case has a detection unit 3 for detecting a contact point between a human operator and the robotic device 1 for a collision between the human operator and the robotic device 1, a geometry of the robotic device at the contact point, and a spatial boundary condition of the collision. In the example shown, the contact point a, spatial condition b and geometry c are predefined by a user 5 of the control unit 2.

The control unit 2 also has a computing unit 4 for determining, under consideration of the spatial boundary condition b of the collision, whether the collision is a clamp-free collision or a clamped collision, and for calculating the permissible maximum speed of the robotic device 1 at the contact point a with a free-impact model if the collision is a clamp-free collision, and with a clamping-impact model or with a quasi-static-clamping model if the collision is a clamped collision. The models are different models in each case. The computing unit 4 is also configured here to output a signal g dependent on the calculated permissible maximum speed for the robotic device 1.

In the example shown, the control unit 2 retrieves a joint configuration d from the robotic device 1 for the time of the collision as well as tool data e, which describe a tool of the robotic device 1. In addition, a torque or force threshold value f is also retrieved from the robotic device. In the example shown, the computing unit 4 retrieves a predefined kinematic structure of the robotic device 1 from a machine database 5, as well as other data of the robotic device, such as mass, inertia, center of gravity for joints and motors of the robotic device, in the example shown. Torque data are also retrieved here. The stored models, i.e., free-impact model, clamping-impact model and quasi-static-clamping model, are retrieved correspondingly from a model database 6 and an associated biomechanics database 7, along with associated values such as limit values, stiffness characteristic curves and the mass of the human body site affected by the collision.

FIG. 2 shows an example of the resulting stiffness characteristic curve h as a function of the force F over the formation D. The permissible penetration depth x2 corresponds to the deformation D at the intersection of the permissible biomechanical contact force y2 and the resulting stiffness characteristic curve h. The reaction distance x1 of the robotic device results from the set reaction force y1 of the robotic device and the resulting stiffness characteristic curve h. The permissible braking distance of the robotic device results in turn from the permissible penetration depth x2 minus the reaction distance x1.

FIG. 3 shows a substitute model for the free-impact model and the clamping-impact model. In both cases, it is assumed that the robotic device 1 moves at a collision speed v_{C} at the point of collision. An effective drive mass m_{D} moves here, coupled via an effective stiffness c_{T} of the drive train with an effective mass of the axes m_{L}, which in turn transmits a contact force F(t) via an effective stiffness c_{M} at the machine surface. The effective masses m_{D}, m_{L} may move here by different distances x_{D}, x_{L}.

In a three-mass oscillator model, as shown in FIG. 3 top right, a finite effective mass of the operator m_{H} is coupled with the contact force F(t) via a stiffness c_{H} of the human. Accordingly, in the example shown, the free-impact model is a three-mass oscillator model with the masses m_{D}, m_{L} and m_{H}. In the case of a clamped impact, the operator 5 is assumed to be immobile, as shown in FIG. 3, bottom right. The stiffness c_{H} of the human, which represents a soft tissue, thus absorbs the entire contact force F(t). Since only two masses m_{D}, m_{L} are considered in this approach, the clamped impact model is a two-mass oscillator model.

1-12. (canceled)

13. A method for predefining a permissible maximum speed for a robotic device, comprising:
predefining a contact point between a human operator and the robotic device for a collision between the human operator and the robotic device, a geometry of the robotic device at the contact point, and a spatial boundary condition of the collision;
under consideration of the spatial boundary condition, determining whether the collision is a clamp-free collision or a clamped collision using a computing unit;
calculating, by the computing unit, the permissible maximum speed of the robotic device at the contact point with a free-impact model if the collision is a clamp-free collision, and with a clamping-impact model or with a quasi-static-clamping model if the collision is a clamped collision, wherein the models in each case are different models;
outputting, by the computing unit, a signal dependent on the calculated permissible maximum speed for the robotic device.

14. The method according to claim 13, wherein the output signal represents a location-dependent speed specification along a machine path predefined for the robotic device, said speed specification being generated in particular by scaling a speed specification predefined originally for the predefined machine path in dependence on the calculated maximum speed, wherein the scaling may comprise a uniform scaling or a scaling adapted locally to the predefined machine path under consideration of a predefined process speed for the robotic device at one or more sub-sections of the machine path.

15. The method according to claim 13, wherein the permissible maximum speed is calculated in real time and the output signal represents an instantaneous permissible maximum speed for the robotic device.

16. The method according to claim 13, wherein if the collision is a clamped collision, the permissible maximum speed is calculated with the clamping-impact mode and with the quasi-static-clamping model, and the lower of the calculated maximum speeds is selected as the permissible maximum speed for the output.

17. The method according to claim 13, wherein in the quasi-static-clamping model the permissible maximum speed is calculated in dependence on:
a) a predefined kinematic structure of the robotic device;
b) a joint configuration at the time of the collision, in particular with a position of one or more axes of the robotic device and speeds assigned to the respective axes;
c) a stiffness characteristic curve of a human body site at the contact point of the collision;
d) a stiffness characteristic curve of a machine point at the contact point of the collision;
e) a resultant stiffness characteristic curve calculated with the stiffness characteristic curve of the human body site and the stiffness characteristic curve of the machine point;
f) a predefined permissible maximum deformation, in particular with a force threshold value and/or an energy threshold value and/or a deformation threshold value;
g) a permissible penetration depth calculated with the stiffness characteristic curve of the machine point and the resultant stiffness characteristic curve;
h) a reaction force of the robotic device;
i) a reaction distance of the robotic device calculated with the stiffness characteristic curve of the machine point and the permissible penetration depth;
j) a permissible braking distance of the robotic device calculated with the predefined permissible maximum deformation and the reaction force; and
k) an actual braking distance of the robotic device.

18. The method according to claim 17, wherein the permissible maximum speed for the robotic device is ascertained iteratively by a bisection method until the actual braking distance matches the permissible braking distance.

19. The method according to claim 13, wherein if the collision involves contact points at different human body sites, the output signal is dependent on the permissible maximum speed which corresponds to the shortest actual braking distance.

20. The method according to claim 13, wherein if the collision involves contact points at different machine points, the permissible maximum speed for all contact points is calculated and the output signal is dependent on the lowest permissible maximum speed.

21. The method according to claim 13, wherein in the case of the free-impact model and the clamping-impact model, the permissible maximum speed is calculated in each case in dependence on:
a) the predefined kinematic structure of the robotic device;
b) the joint configuration at the time of the collision, in particular with a position of one or more axes of the robotic device and speeds assigned to the respective axes;
c) the stiffness characteristic curve of the human body site at the contact point of the collision;
d) the stiffness characteristic curve of the machine point at the contact point of the collision;
e) the resultant stiffness characteristic curve calculated with the stiffness characteristic curve of the human body site and the stiffness characteristic curve of the machine point;
f) the permissible maximum deformation predefined with a force threshold value and/or an energy threshold value;
l) an effective mass of the machine point at the contact point of the collision;
m) an effective stiffness of the robotic device; and, only in the case of the free-impact model:
n) an effective mass of the human body site at the contact point of the collision.

22. The method according to claim 21, wherein the free-impact model comprises or is a three-mass oscillator model and/or the clamping-impact model comprises or is a two-mass oscillator model.

23. A control unit for predefining a permissible maximum speed of a robotic device, comprising:
a detection unit for detecting a contact point between a human operator and the robotic device for a collision between a human operator and robotic device, a geometry of the robotic device at the contact point, and a spatial boundary condition of the collision;
a computing unit for determining, under consideration of the spatial boundary condition, whether the collision is a clamp-free collision or a clamped collision, and for calculating the permissible maximum speed of the robotic device at the contact point with a free-impact model if the collision if a clamp-free collision and with a clamping-impact model or with a quasi-static-clamping model if the collision is a clamped collision, wherein the models are different models in each case, and for outputting a signal dependent on the calculated permissible maximum speed for the robotic device.

24. A robotic device with a control unit according to claim 23.
